(19) United States
(12) Patent Application Publication
(10) Pub. No.: US 2015/0139558 A1
(43) Pub. Date: May 21, 2015

(54) SEARCHING DEVICE, SEARCHING METHOD, AND COMPUTER PROGRAM PRODUCT

(71) Applicant: KABUSHIKI KAISHA TOSHIBA, Tokyo (JP)

(72) Inventors: Masashi NISHIYAMA, Kawasaki Kanagawa (JP); Hidetaka OHIRA, Kawasaki Kanagawa (JP); Masahiro SEKINE, Fuchu Tokyo (JP); Yusuke TAZOE, Kokubunji Tokyo (JP); Kaoru SUGITA, Iruma Saitama (JP)

(73) Assignee: KABUSHIKI KAISHA TOSHIBA, Tokyo (JP)

(21) Appl. No.: 14/543,289

(22) Filed: Nov. 17, 2014

(30) Foreign Application Priority Data
Nov. 20, 2013 (JP) 2013-239802

(51) Int. Cl. G06K 9/62

(52) U.S. Cl. CPC G06K 9/6202
USPC 382/220

(57) ABSTRACT

According to an embodiment, a searching device includes an acquiring unit, a receiver, a calculator, and a determining unit. The acquiring unit is configured to acquire a first image. The receiver is configured to receive selection of a first area contained in the first image. The calculator is configured to calculate, for each of a plurality of second images to be searched, a first similarity with the first area and a second similarity with a second area that has been received by the receiver before the first area. The determining unit is configured to determine a third image or third images to be presented from among the second images on the basis of a result of a logical operation of the first similarity and the second similarity for each of the second images.

### CROSS-REFERENCE TO RELATED APPLICATION

This application is based upon and claims the benefit of priority from Japanese Patent Application No. 2013-239802, filed on Nov. 20, 2013; the entire contents of which are incorporated herein by reference.

### FIELD

An embodiment described herein relates generally to a searching device, a searching method, and a computer program product therefor.

### BACKGROUND

To search for an intended product, technologies for specifying an area in an image and searching for an image containing an area similar to the specified area are disclosed.

The technologies of the related art, however, only allow searching for images containing an area similar to a specified area but cannot provide sequential and interactive searching in which transition of the user's interest is reflected.

### BRIEF DESCRIPTION OF THE DRAWINGS

FIG. 1 is a block diagram illustrating a functional configuration of a searching device;

FIG. 2 illustrates second images, a first image, a first area, and a second area;

FIG. 3 is a diagram explaining positions in an image;

FIG. 4 is an explanatory diagram of a method for determining a third image;

FIG. 5 is an explanatory diagram of a method for determining a third image;

FIG. 6 is a flowchart illustrating procedures of a search process;

FIG. 7 illustrates transition of images; and

FIG. 8 illustrates display control.

### DETAILED DESCRIPTION

According to an embodiment, a searching device includes an acquiring unit, a receiver, a calculator, and a determining unit. The acquiring unit is configured to acquire a first image. The receiver is configured to receive selection of a first area contained in the first image. The calculator is configured to calculate, for each of a plurality of second images to be searched, a first similarity with the first area and a second similarity with a second area that has been received by the receiver before the first area. The determining unit is configured to determine a third image or third images to be presented from among the second images on the basis of a result of a logical operation of the first similarity and the second similarity for each of the second images.

An embodiment of a searching device, a searching method, and a program therefor will be described in detail below with reference to the accompanying drawings.

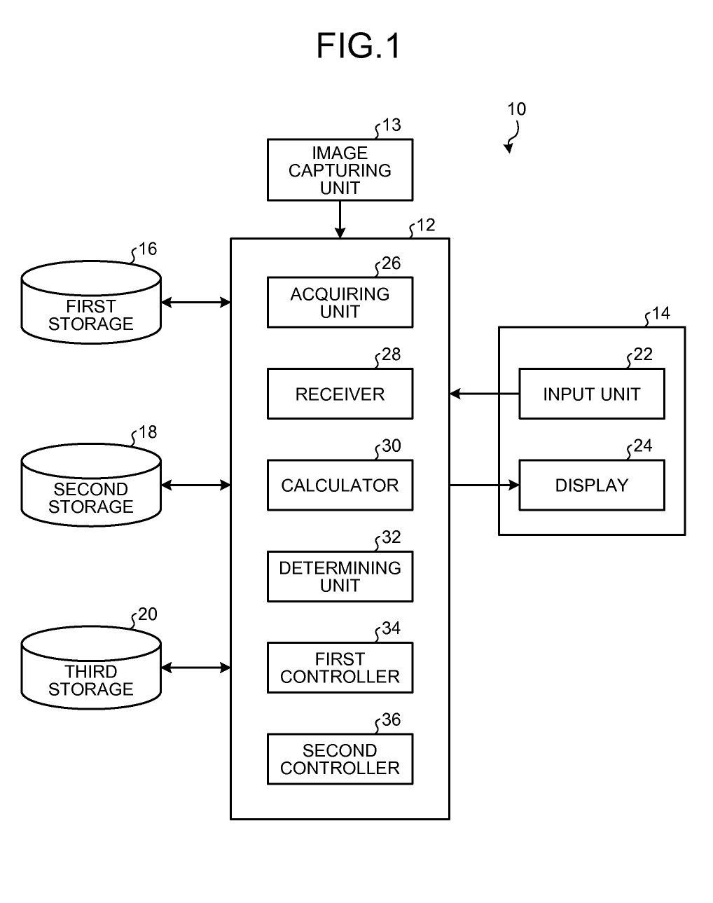

FIG. 1 is a block diagram illustrating a functional configuration of a searching device 10 according to the present embodiment. The searching device 10 includes a controller 12, an image capturing unit 13, an input unit 22, a display 24, a first storage 16, a second storage 18, and a third storage 20.

In the present embodiment, description will be made on a case in which the searching device 10 is a portable terminal (such as a smart phone or a tablet personal computer (PC)) including the controller 12, the image capturing unit 13, the input unit 22, the display 24, the first storage 16, the second storage 18, and the third storage 20 that are integrated. Note that the searching device 10 is not limited to a portable terminal. For example, the searching device 10 may be configured such that at least one of the image capturing unit 13, the input unit 22, the display 24, the first storage 16, the second storage 18, and the third storage 20 is provided separately from the controller 12. In this case, an example of the searching device 10 is a PC.

The searching device 10 will be described in detail below.

The display 24 displays various images (details will be described later). Examples of the display 24 include a known liquid crystal display (LCD), cathode ray tube (CRT), and plasma display panel (PDP).

The input unit 22 is means for a user to make various operational inputs. Examples of the input unit 22 include a mouse, a button, a remote controller, a keyboard, and a speech recognition device such as a microphone.

The input unit 22 and the display 24 may be integrated. Specifically, the input unit 22 and the display 24 may constitute a user interface (UI) unit 14 having both inputting functions and displaying functions. Examples of the UI unit 14 include an LCD with a touch panel.

The image capturing unit 13 acquires a first image through imaging. The image capturing unit 13 is a known digital camera, digital video camera, or the like. When an imaging instruction is input through an operational instruction given to the UI unit 14 by the user, the image capturing unit 13 captures an object to acquire the first image. The image capturing unit 13 outputs the first image acquired through imaging to the controller 12.

The first image is an image containing a first area.

The first area is an area contained in the first image. The first area is an area that occupies a certain range in the first image and that can be compared. The first area may be an area representing the entire first image or a partial area of the first image. In the present embodiment, a case in which the first area is a partial area of the first image will be described.

When the first image is an image of clothing, the first area is a collar, a sleeve, a button, a pattern, a logo, or a mark, for example. The first area is selected through an operational instruction given to the UI unit 14 by the user. Specifically, the user operates the input unit 22 while checking the first image displayed on the display 24 of the UI unit 14 to specify the first area in the first image.

The first image is an image used by the user for specifying the first area in the searching device 10. The first image may be any image including the first area.

Specifically, the first image may be an image relating to garments, an image relating to furniture, an image relating to traveling, an image relating to home electric appliances, or the like, but is not limited thereto.

An image relating to garments is specifically an image of an object relating to accessories and beauty such as an object used for garments or a hair style that is visible. Accessories include clothes and ornaments. Examples of clothes include outerwear, a skirt, pants, shoes, and a hat. Examples of ornaments include crafts for adorning oneself such as a ring, a necklace, a pendant, and earrings. An object relating to beauty includes a hair style, cosmetics that are applied on the skin, and the like.

In the present embodiment, a case in which the first image is an image of clothing will be described as an example.

The first storage 16 is a storage medium such as a hard disk drive (HDD). The first storage 16 stores multiple second images in advance. The second images are images to be searched with the searching device 10. A second image is an image of a product or relating to a product, for example, but is not limited thereto. More specifically, a second image is an image relating to garments, an image relating to furniture, an image relating to traveling, an image relating to home electric appliances, or the like, but is not limited thereto. In the present embodiment, a case in which the second images are images of clothing will be described as an example.

The second storage 18 is a storage medium such as a hard disk drive (HDD). The second storage 18 stores the first area and a second area. The second area refers to the first area received from the UI unit 14 before the last first area received by the controller 12 from the UI unit 14. Thus, the second storage 18 stores the last first area received by the controller 12 from the UI unit 14 as the first area, and a first area received before the last first area by the controller 12 from the UI unit 14 as the second area.

Specifically, the second storage 18 stores a first area, first identification information indicating the first area, and the date and time when the first area was selected in association with one another. The second storage 18 also stores a second area, second identification information indicating the second area, and the date and time when the second area was selected as a first area in association with one another.

The third storage 20 is a storage medium such as a hard disk drive (HDD). The third storage area 20 stores a second area and the date and time when the second area was selected as a first area in association with each other.

In the present embodiment, a case in which the first storage 16, the second storage 18, and the third storage 20 are separately provided will be described. At least two of the first storage 16, the second storage 18, and the third storage 20, however, may be integrated. In this case, one storage may be divided into multiple memory areas, and pieces of information stored in at least one of the first storage 16, the second storage 18, and the third storage 20 may be individually stored in the respective memory areas.

The controller 12 is a computer including a central processing unit (CPU), a read only memory (ROM), a random access memory (RAM), and the like. The controller 12 controls the entire searching device 10. Furthermore, the controller 12 is electrically connected to the image capturing unit 13, the first storage 16, the second storage 18, the third storage 20, and the UI unit 14.

The controller 12 includes an acquiring unit 26, a receiver 28, a calculator 30, a determining unit 32, a first controller 34, and a second controller 36. Some or all of the acquiring unit 26, the receiver 28, the calculator 30, the determining unit 32, the first controller 34, and the second controller 36 may be implemented by making a processor such as a CPU execute programs, that is, by software, may be implemented by hardware such as integrated circuits (ICs), or may be implemented by combination of software and hardware, for example.

The acquiring unit 26 acquires the first image. In the present embodiment, the acquiring unit 26 acquires the first image from the image capturing unit 13.

Note that the acquiring unit 26 may acquire one of the second images stored in the first storage 16 as the first image. In this case, one of the second images stored in the first storage 16 is selected through an operational instruction given to the UI unit 14 by the user, for example. The acquiring unit 26 may acquire the selected second image as the first image.

Alternatively, when third images (details of which will be described later) are displayed on the display 24 as a result of a search process, which will be described later, the acquiring unit 26 acquires one third image as the first image. Specifically, when multiple third images are displayed on the display 24, the acquiring unit 26 acquires one third image selected from the third images through an operational instruction given to the UI unit 14 by the user.

The first controller 34 performs control to display various images, data, and the like on the display 24. For example, the first controller 34 performs control to display the first image acquired by the acquiring unit 26 on the display 24.

The receiver 28 receives selection of the first area in the first image. Through an operational instruction given to the UI unit 14 by the user, the first area contained in the first image displayed on the display 24 is selected. The UI unit 14 then outputs the selected first area to the controller 12.

More specifically, when an operational instruction is given to the input unit 22 after performing control to display the first image on the display 24, the first controller 34 performs control to display a boundary box on the display 24. The user then selects a desired first area in the first image displayed on the display 24 through the operational instruction to the input unit 22 by setting the boundary box. The UI unit 14 then outputs the selected first area to the controller 12.

The receiver 28 receives the first area from the UI unit 14 to receive the selection of the first area in the first image. The second area specifically refers to a first area received by the receiver 28 before selection of another first area is received by the receiver 28.

The UI unit 14 may also output position information indicating a position in the first image selected through an operational instruction given to the input unit 22 by the user to the receiver 28. In this case, the receiver 28 in receipt of the position information may receive a first area by performing an automatic area clipping using segmentation from the position in the first image specified by the position information.

The second controller 36 performs control to store various information into the first storage 16, the second storage 18, or the third storage 20. The second controller 36 also performs control to delete and update various information from and in the first storage 16, the second storage 18, or the third storage 20.

In the present embodiment, when the receiver 28 receives selection of the first area, the second controller 36 performs control to store the first area in association with the first identification information into the second storage 18. In addition, when a third image is determined by the determining unit 32, which will be described later, the second controller 36 performs control to store the first area as a second area into the second storage 18.

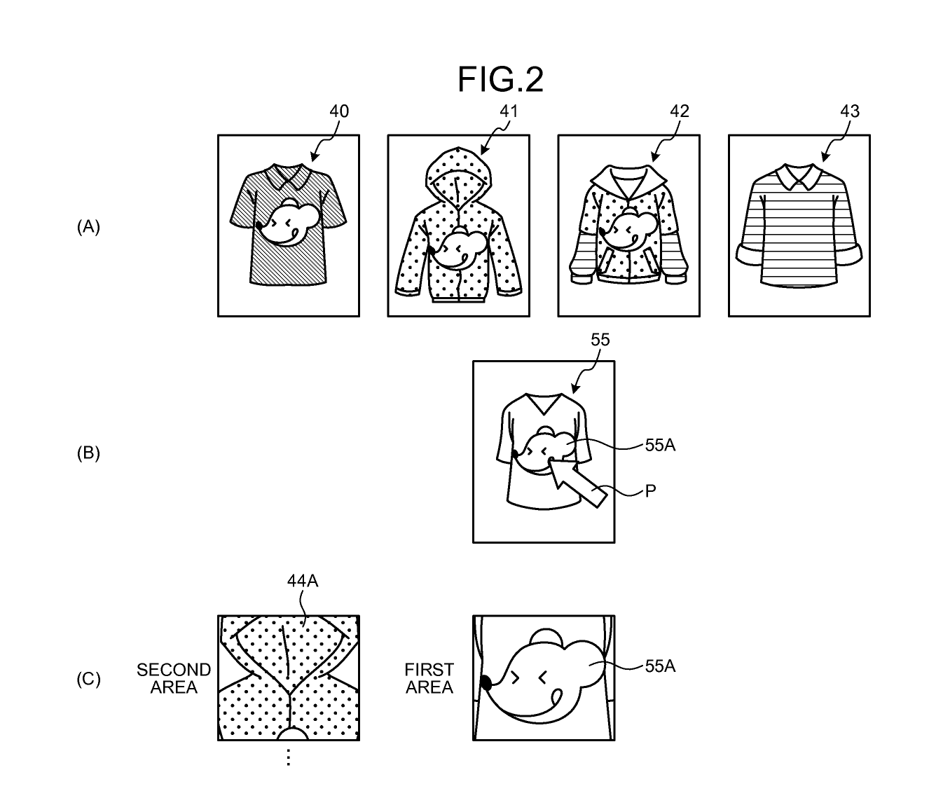

FIG. 2 illustrates second images, a first image, a first area, and a second area. For example, the first storage 16 stores multiple second images 40 to 43 that are images of clothing in advance (see (A) in FIG. 2). For example, the acquiring unit 26 acquires a first image 55 that is an image of clothing with a bear mark in the center (see (B) in FIG. 2). In addition, the receiver 28 is assumed to receive selection of an area 55A of the bear mark in the first image 55 as selection of the first area from the UI unit 14 (see P in (B) in FIG. 2).

In this case, the second controller 36 performs control to store the area 55A as the first area in association with first identification information indicating the first area into the second storage 18 (see (C) in FIG. 2). The second controller 36 also performs control to store an area 44A that is a first area received by the receiver 28 before the first area and stored in the second storage 18 in association with second identification information indicating a second area into the second storage 18 (see (C) in FIG. 2). In this manner, the second controller 36 performs control to store a first area, which is received before the last first area received by the receiver 28, as a second area into the second storage 18.

The description refers back to FIG. 1, in which the calculator 30 calculates first similarity and second similarity of each of the second images to be searched stored in the first storage 16. The first similarity refers to similarity between a second image and the first area. The second similarity refers to similarity between a second image and a second area.

Specifically, the calculator 30 calculates a first feature of the first area and a third feature of a third area corresponding to the first area in a second image. The calculator 30 then calculates the first similarity by using the first feature and the second feature. The calculator 30 also calculates a second feature of a second area and a fourth feature of a fourth area corresponding to the second area in the second image. The calculator 30 then calculates the second similarity by using the second feature and the fourth feature.

A known method may be used for determining the third area in a second image. Similarly, a known method may be used for determining the fourth area in a second image.

The features including the first feature, the second feature, the third feature, and the fourth feature are numerical values obtained by analyzing the respective areas. The respective areas refer to the first area, the second area, the third area, and the fourth area described above. The numerical values are numerical values corresponding to features of the respective areas or combinations thereof. In the following description, for collectively referring to the first feature, the second feature, the third feature, and the fourth feature, the term features will be simply used.

Specifically, the calculator 30 defines a first condition for calculating the features in advance. The first condition is a type or the like that classifies the colors of the areas, the shapes of the areas and the areas according to predetermined conditions, for example.

For example, the calculator 30 calculates a value obtained by quantifying the color (pixel values of R, G, and B) of the first area, the shape of the first area, and the type of the first area as the first feature. The calculator 30 also calculates a value obtained by quantifying the color (pixel values of R, G, and B) of the third area, the shape of the third area, and the type of the third area as the third feature.

Similarly, the calculator 30 calculates a value obtained by quantifying the color (pixel values of R, G, and B) of the second area, the shape of the second area, and the type of the second area as the second feature. The calculator 30 also calculates a value obtained by quantifying the color (pixel values of R, G, and B) of the fourth area, the shape of the fourth area, and the type of the fourth area as the fourth feature.

Thus, the calculator 30 calculates HoG features, SIFT features, or combinations thereof as the features according to the first condition. The first condition may be set as appropriate and is not limited to the aforementioned condition.

The calculator 30 may calculate the second feature by reading the second feature associated with the second area from the second storage 18. In this case, the second controller 36 stores the first feature in association with the first area and the first identification information into the second storage 18 each time the first feature of the first area is calculated by the calculator 30. The first area is stored as a second area into the second storage 18 by the second controller 36 when a third image is determined by the determining unit 32, which will be described later, as described above. Thus, the second controller 36 brings the second storage 18 into a state in which the second area, the second feature, and the second identification information are stored in association with one another. The calculator 30 may then calculate the second feature by reading the second feature from the second storage 18.

Subsequently, the calculator 30 calculates the first similarity by calculating the similarity between the first feature and the third feature. The calculator 30 also calculates the second similarity by calculating the similarity between the second feature and the fourth feature.

For example, the calculator 30 calculates the first similarity in a manner that the first similarity when the first feature and the third feature are equal is “1”, the first similarity when the first feature and the third feature are different from each other by a predetermined value or larger is “0”, and the first similarity becomes larger toward “1” from “0” as the values of the first feature and the third feature are closer to each other.

Similarly, the calculator 30 calculates the second similarity in a manner that the second similarity when the second feature and the fourth feature are equal is “1”, the second similarity when the second feature and the fourth feature are different from each other by a predetermined value or larger is “0”, and the second similarity becomes larger toward “1” from “0” as the values of the second feature and the fourth feature are closer to each other.

Specifically, the calculator 30 may calculate the first similarity and the second similarity by using the sum of squared difference (SSD), the sum of absolute difference (SAD), the normalized cross correlation, or the like.

The calculator 30 may calculate the first similarity and the second similarity taking geometric relations of the areas in the images into account. The geometric relations refer to at least one of the positions of the areas in the images, the sizes (ratios) of the areas in the images, the ranges (proportions) of the areas in the images, the correlations of color histograms of the areas in the images, and the correlations of intensity-gradient histogram of the areas in the images.

In this case, the calculator 30 calculates the first similarity for each of the second images by using the first feature, a geometric relation of the first area in the first image, the third feature, and a geometric relation of the third area in the second image. The calculator 30 also calculates the second similarity for each of the second images by using the second feature, a geometric relation of the second area in the first image, the fourth feature, and a geometric relation of the fourth area in the second image.

Note that the geometric relation of the first area in the first image, the geometric relation of the third area in the second image, the geometric relation of the second area in the first image, and the geometric relation of the fourth area in the second image may be geometric relations of the areas in the respective images or may be geometric relations of the areas in clothing areas contained in the respective images.

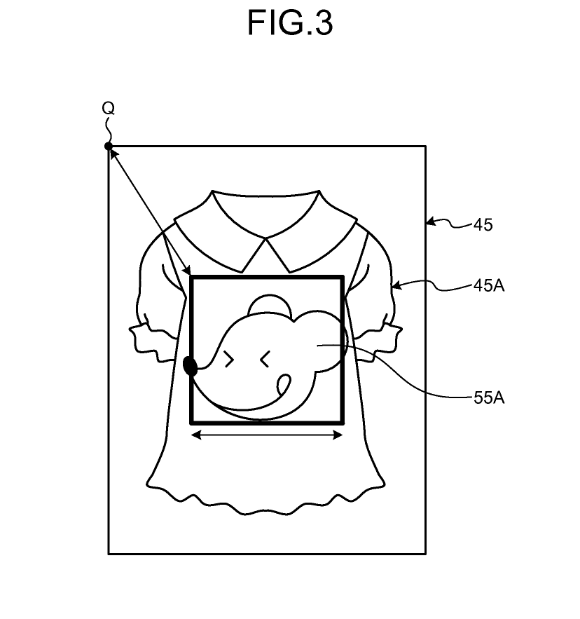

FIG. 3 is a diagram explaining positions of the areas in an image as an example of the geometric relations. As illustrated in FIG. 3, the position of the fourth area 55A in the second image 45 is represented by position coordinates with respect to a certain position (a position Q, for example) in the second image 45 set to the origin, for example. Alternatively, the position of the fourth area 55A in the second image 45 may be information indicating a relative position in a clothing area 45A contained in the second image 45.

When the sizes (ratios) of the respective areas in the image are used as the geometric relations, the size of the fourth area 55A in the second image 45 in FIG. 3 may be represented by the ratio of the width of the fourth area 55A to that of the second image 45. Alternatively, the size of the fourth area 55A in the second image 45 may be the ratio of the height of the fourth area 55A to that of the second image 45. Still alternatively, the size of the fourth area 55A in the second image 45 may be the ratio of the ratio of the height to the width of the fourth area 55A to that of the ratio of the height to the width of the second image 45.

The same applies to the position and the size of the first area in the first image, the position and the size of the third area in the second image, and the position and the size of the second area in the first image.

Note that the calculator 30 may use at least one of the positions of the areas in the images, the sizes (ratios) of the areas in the images, the ranges (proportions) of the areas in the images, the correlations of color histograms of the areas in the images, and the correlations of intensity-gradient histograms of the areas in the images, and may combine some of these values (positions, sizes, ranges, correlations of color histograms, and correlations of intensity-gradient histograms).

The description refers back to FIG. 1, in which the calculator 30 in this case sets the first similarity to “1” when the first feature and the third feature are equal and the position of the first area in the first image and the position of the third area in the second image are equal. The calculator 30 sets the first similarity to “0” when the first feature and the third feature are different from each other by a predetermined value or larger and the position of the first area in the first image and the position of the third area in the second image are different from each other by a predetermined value or larger. The calculator 30 then calculates the first similarity in a manner that the first similarity becomes larger toward “1” from “0” as the values of the first feature and the third feature are closer to each other and as the position of the first area in the first image and the position of the third area in the second image area closer to each other.

Similarly, the calculator 30 sets the second similarity to “1” when the second feature and the fourth feature are equal and the position of the second area in the first image and the position of the fourth area in the second image are equal. The calculator 30 also sets the first similarity to “0” when the second feature and the fourth feature are different from each other by a predetermined value or larger and the position of the second area in the first image and the position of the fourth area in the second image are different from each other by a predetermined value or larger. The calculator 30 then calculates the second similarity in a manner that the second similarity becomes larger toward “1” from “0” as the values of the second feature and the fourth feature are closer to each other and as the position of the second area in the first image and the position of the fourth area in the second image area closer to each other.

The determining unit 32 determines a second image that is similar or dissimilar to both of the first area and the second area from among the second images to be a third image to be presented to the user. The third image is an image determined to be an image to be presented to the user from among the second images.

In the present embodiment, the determining unit 32 performs logical operation of the first similarity and the second similarity for each of the second images. The determining unit 32 determines the third image to be presented to the user from among the second images on the basis of the result of the logical operation.

The determining unit 32 performs logical operation using at least one of the logical product (AND), the logical sum (OR), the negation (NOT), and the exclusive OR (XOR).

For the determining unit 32, the type of the logical operation to be used is set in advance, for example. For example, a memory, which is not illustrated, of the determining unit 32 stores any of the logical product (AND), the logical sum (OR), the negation (NOT), and the exclusive OR (XOR). The type of the logical operation can be changed as appropriate through an operational instruction to the UI unit 14.

The determining unit 32 thus performs the preset type of logical operation to obtain the result of the logical operation of the first similarity and the second similarity for each of the second images.

When no second area is stored in the second storage 18, the calculator 30 calculates only the first similarity. In this case, the determining unit 32 may use the first similarity as the operation result. Specifically, in this case, the determining unit 32 may obtains the result of the logical operation of the first similarity and the second similarity for each of the second images by using an empty set as the second similarity.

Multiple second areas are assumed to be stored in the second storage 18. In this case, the calculator 30 calculates the second similarities with the respective second areas for each of the second images. The determining unit 32 obtains the result of logical operation of the first similarity and each of the second similarities for each second image.

Thus, when multiple second areas are stored in the second storage 18, the determining unit 32 obtains multiple operation results for one second image as the results of the logical operation of the first similarity and the respective second similarities.

Alternatively, when multiple second areas are stored in the second storage 18 and multiple second similarities are calculated by the calculator 30 for each second image, the calculator 30 may obtain one operation result for one second image.

In this case, the memory, which is not illustrated, of the determining unit 32 stores the order of logical operations and the types of logical operations in association with each other in advance, for example.

For example, the memory stores in advance the type of logical operation “logical product (AND)” associated with the order of logical operation “1”, the type of logical operation “logical sum (OR)” associated with the order of logical operation “2”, and the type of logical operation “logical product (AND)” associated with the order of logical operation “3”. The type of logical operation associated with the order of logical operation can be changed as appropriate through an operational instruction given to the UI unit 14 by the user.

The determining unit 32 then performs the type of logical operation associated with the order of logical operation “1” on the first similarity and a second similarity on which the logical operation has not been performed from among the multiple second similarities for each of the second images. Each time a logical operation is performed, the determining unit 32 then repeats a series of processes of incrementing the order of logical operation by one and performs the type of logical operation associated with the order of logical operation on the result of previous operation and one of the second similarities on which the logical operation has not been performed. The determining unit 32 uses the operation result that is finally obtained as the operation result associated with the second image. In this manner, the determining unit 32 can obtain one operation result even when multiple second similarities are calculated for one second image.

The determining unit 32 determines a predetermined number of second images in descending order or in ascending order of the results of logical operations of the first similarity and the second similarities calculated for each of the second images to be third images.

The determining unit 32 stores information indicating the ascending order or the descending order and information indicating the predetermined number (hereinafter referred to as the displayed number) in the memory, which is not illustrated, in advance, for example. If information indicating the “descending order” is stored in the memory, the determining unit 32 then determines the displayed number of second images in descending order of the results of logical operations of the first similarity and the second similarities calculated for each of the second images to be third images.

If information indicating the “ascending order” is stored in the memory, the determining unit 32 then determines the displayed number of second images in ascending order of the results of logical operations of the first similarity and the second similarities calculated for each of the second images to be third images.

The information indicating the “ascending order” or the “descending order” stored in the memory, which is not illustrated, of the determining unit 32 can be changed as appropriate through an operational instruction given to the UI unit 14 by the user.

For example, the first controller 34 performs control to display a first button for indicating a liked first area in the first image and a second button for indicating a disliked first area in the first image on the display 24. When the first button is specified through an operational instruction given to the input unit 22 by the user, the UI unit 14 outputs information indicating that the first button is specified to the controller 12. When the second button is specified through an operational instruction given to the input unit 22 by the user, the UI unit 14 outputs information indicating that the second button is specified to the controller 12.

Upon receiving the information indicating that the first button is specified from the UI unit 14, the determining unit 32 of the controller 12 stores the information indicating “descending order” into the memory, which is not illustrated. Upon receiving the information indicating that the second button is specified from the UI unit 14, the determining unit 32 stores the information indicating “ascending order” into the memory, which is not illustrated.

Assume that the determining unit 32 has determined the predetermined displayed number of second images in ascending order the results of logical operation of the first similarity and the second similarities calculated for each of the second images to be third images on the basis of the information indicating “ascending order”. In this case, the determining unit 32 determines second images that are dissimilar to both of the first area and the second area from among the second images to be the third images to be presented to the user.

In contrast, assume that the determining unit 32 has determined the predetermined displayed number of second images in descending order the results of logical operation of the first similarity and the second similarities calculated for each of the second images to be third images on the basis of the information indicating “descending order”. In this case, the determining unit 32 determines second images that are similar to both of the first area and the second area from among the second images to be the third images to be presented to the user.

The displayed number can be similarly changed as appropriate through an operational instruction given to the UI unit 14 by the user.

The method for determining third images will be described more specifically.

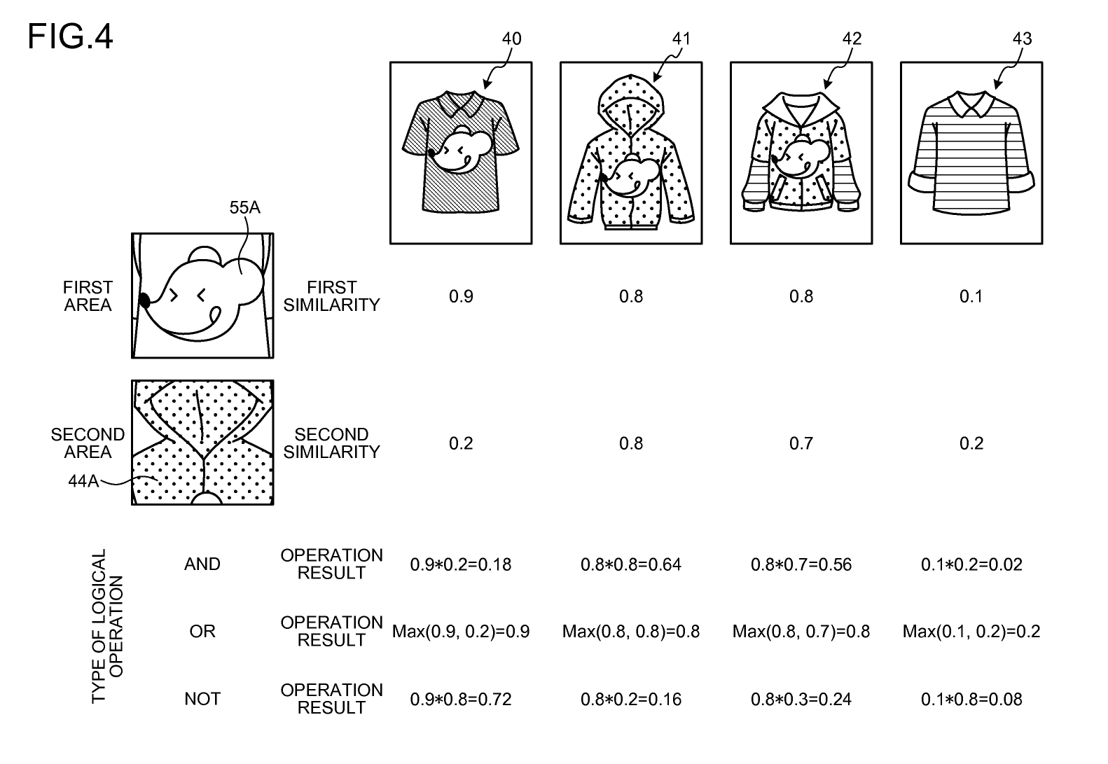

FIG. 4 is an explanatory diagram of the method for determining third images. As illustrated in FIG. 4, assume that multiple second images 40 to 43 that are images of clothing are stored as the second images in the first storage 16 in advance, for example. In addition, assume that the first area acquired by the acquiring unit 26 is the bear mark area 55A, for example. Furthermore, assume that the second area is the dotted pattern area 44A.

In this case, the calculator 30 calculates the first similarity with the area 55A that is the first area and the second similarity with the area 44A that is the second area for each of the second images 40 to 43.

In the example illustrated in FIG. 4, the first similarity with the area 55A of the second image 40 is “0.9” and the second similarity with the area 44A thereof is “0.2”. The first similarity with the area 55A of the second image 41 is “0.8” and the second similarity with the area 44A thereof is “0.8”. The first similarity with the area 55A of the second image 42 is “0.8” and the second similarity with the area 44A thereof is “0.7”. The first similarity with the area 55A of the second image 43 is “0.1” and the second similarity with the area 44A thereof is “0.2”.

Subsequently, the determining unit 32 obtains the result of logical operation of the first similarity and the second similarity for each of the second images 40 to 43.

For example, assume that information indicating the type of logical operation “logical product (AND)” is stored in advance in the memory, which is not illustrated, of the determining unit 32.

In this case, the determining unit 32 obtains the result of the logical product (AND) of the first similarity and the second similarity for each of the second images 40 to 43. As a result, the results for the respective second images 40 to 43 are “0.18”, “0.64”, “0.56”, and “0.02”. When the “descending order” and the displayed number “2” are stored in the memory, which is not illustrated, the determining unit 32 determines two second images 41 and 42 in the descending order of the operation results to be the third images to be presented to the user.

Alternatively, for example, assume that information indicating the type of logical operation “logical sum (OR)” is stored in advance in the memory, which is not illustrated, of the determining unit 32.

In this case, the determining unit 32 obtains the result of the logical sum (OR) of the first similarity and the second similarity for each of the second images 40 to 43. As a result, the results for the respective second images 40 to 43 are “0.9”, “0.8”, “0.8”, and “0.2”. When the “descending order” and the displayed number “3” are stored in the memory, which is not illustrated, the determining unit 32 determines three second images 40, 41 and 42 in the descending order of the operation results to be the third images to be presented to the user.

Alternatively, for example, assume that information indicating the type of logical operation “negation (NOT)” is stored in advance in the memory, which is not illustrated, of the determining unit 32.

In this case, the determining unit 32 obtains the result of the negation (NOT) of the first similarity and the second similarity for each of the second images 40 to 43. As a result, the results for the respective second images 40 to 43 are “0.72”, “0.16”, “0.24”, and “0.08”. When the “descending order” and the displayed number “2” are stored in the memory, which is not illustrated, the determining unit 32 determines two second images 40 and 42 in the descending order of the operation results to be the third images to be presented to the user.

Alternatively, the determining unit 32 may determine the third images by using truth values.

Specifically, the determining unit 32 sets a first truth value that defines the first similarity as being true when the first similarity exceeds a first threshold and defines the first similarity as being false when the first similarity is equal to or smaller than the first threshold. In addition, the determining unit 32 sets a second truth value that defines the second similarity as being true when the second similarity exceeds a second threshold and defines the second similarity as being false when the second similarity is equal to or smaller than the second threshold. These first threshold and second threshold may be adjusted as appropriate and may be the same value or different values.

Furthermore, the determining unit 32 may determine the third images on the basis of a result of operation of the first truth value for the first similarity and the second truth value for the second similarity.

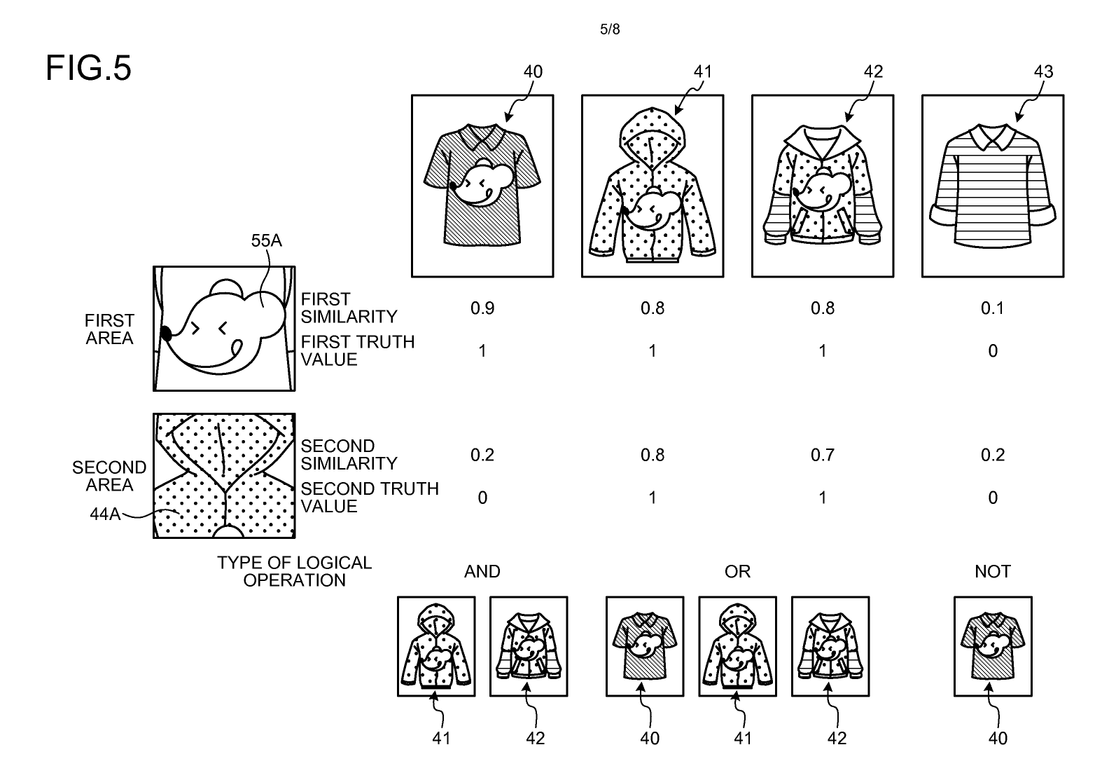

FIG. 5 is an explanatory diagram of the method for determining the third images by using the truth values. As illustrated in FIG. 5, assume that multiple second images 40 to 43 that are images of clothing are stored as the second images in the first storage 16 in advance, for example. In addition, assume that the first area acquired by the acquiring unit 26 is the bear mark area 55A, for example. Furthermore, assume that the second area is the dotted pattern area 44A.

In this case, the calculator 30 calculates the first truth value for the first similarity with the area 55A and the second truth value for the second similarity with the area 44A for each of the second images 40 to 43.

In the example illustrated in FIG. 5, a case in which the first threshold and the second threshold are 0.5 is presented as an example. Furthermore, in the example illustrated in FIG. 5, the first similarity with the area 55A of the second image 40 is “0.9”, the first truth value is “1”, the second similarity with the area 44A thereof is “0.2”, and the second truth value is “0”. The first similarity with the area 55A of the second image 41 is “0.8”, the first truth value is “1”, the second similarity with the area 44A thereof is “0.8”, and the second truth value is “1”. The first similarity with the area 55A of the second image 42 is “0.8”, the first truth value is “1”, the second similarity with the area 44A thereof is “0.7”, and the second truth value is “1”. The first similarity with the area 55A of the second image 43 is “0.1”, the first truth value is “0”, the second similarity with the area 44A thereof is “0.2”, and the second truth value is “0”.

Subsequently, the determining unit 32 obtains the result of logical operation of the first truth value and the second truth value for each of the second images 40 to 43.

For example, assume that information indicating the type of logical operation “logical product (AND)” is stored in advance in the memory, which is not illustrated, of the determining unit 32.

In this case, the determining unit 32 obtains the result of the logical product (AND) of the first truth value and the second truth value for each of the second images 40 to 43. The determining unit 32 then determines the second images 41 and 42 with the operation result “1” to be the third images.

Alternatively, for example, assume that information indicating the type of logical operation “logical sum (OR)” is stored in advance in the memory, which is not illustrated, of the determining unit 32.

In this case, the determining unit 32 obtains the result of the logical sum (OR) of the first truth value and the second truth value for each of the second images 40 to 43. The determining unit 32 then determines the second images 40, 41 and 42 with the operation result “1” to be the third images to be presented to the user.

Alternatively, for example, assume that information indicating the type of logical operation “negation (NOT)” is stored in advance in the memory, which is not illustrated, of the determining unit 32.

In this case, the determining unit 32 obtains the result of the negation (NOT) of the first truth value and the second truth value for each of the second images 40 to 43. As a result, the determining unit 32 determines the second image 40 with the operation result “1” to be the third image to be presented to the user.

The first controller 34 performs control to display the third images determined by the determining unit 32 on the display 24 in addition to the control described above.

Next, a search process performed by the controller 12 will be described.

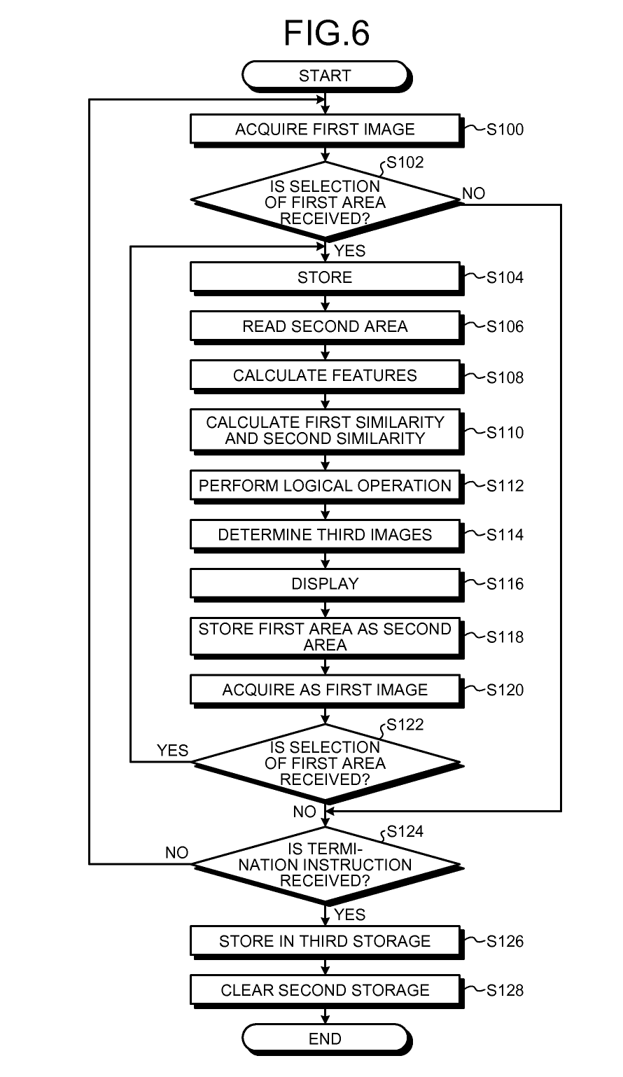

FIG. 6 is a flowchart illustrating procedures of the search process performed by the searching device 10 according to the present embodiment.

First, the acquiring unit 26 acquires a first image from the image capturing unit 13 (step S100). Subsequently, the receiver 28 determines whether or not selection of a first area in the first image acquired in step S100 is received (step S102).

For example, the first controller 34 performs control to display the first image acquired in step S100 on the display 24. The user operates the input unit 22 while checking the first image displayed on the display 24 to input the first area in the first image. The UI unit 14 outputs the first area input by the input unit 22 to the controller 12. The receiver 28 performs the determination in step S102 by determining whether or not the first area is received from the UI unit 14.

If the receiver 28 has not received selection of the first area (step S102: No), the process proceeds to step S124 to be described later. If the receiver 28 receives selection of the first area (step S102: Yes), the process proceeds to step S104.

In step S104, the second controller 36 stores the first area received in step S102 (or in step S122 to be described later) in association with the first identification information indicating the first area and the date and time when the first area was selected into the second storage 18 (step S104). Note that the second controller 36 may store the position information of the searching device 10 when the first area was selected and detail information such as the name of the user operating the searching device 10 when the first area was selected in association in addition to the first area, the first identification information and the date and time when the first area was selected into the second storage 18.

Subsequently, the calculator 30 reads a second area stored in the second storage 18 (step S106). The second storage 18 stores the second area in association with the second identification information. Thus, the calculator 30 performs the processing of step S106 by reading the second area associated with the second identification information.

The calculator 30 calculates features of each of the second images stored in the first storage 16 (step S108). More specifically, the calculator 30 calculates the first feature of the first image received in step S102 (or step S122 to be described later) and the third feature of a third area corresponding to the first area in each of the second images. The calculator 30 also calculates the second feature of the second area read in step S106 and the fourth feature of a fourth area corresponding to the second area in each of the second images.

Subsequently, the calculator 30 calculates the first similarity and the second similarity of each of the second images stored in the first storage 16 (step S110). More specifically, the calculator 30 calculates the first similarity for each of the second images by using the first feature and the third feature calculated in step S108. The calculator 30 also calculates the second similarity for each of the second images by using the second feature and the fourth feature calculated in step S108.

Subsequently, the determining unit 32 performs logical operation of the first similarity and the second similarity calculated for each of the second images (step S112). The determining unit 32 then determines third images to be presented to the user from among the second images on the basis of the result of the logical operation in step S112 (step S114).

Subsequently, the first controller 34 performs control to display the third images determined in step S114 on the display 24 (step S116).

Subsequently, the second controller 36 stores the first area received in step S102 as a second area into the second storage 18 (step S118). The second controller 36 stores the first area stored in the second storage 18 in step S104 as a second area into the second storage 18. Specifically, the second controller 36 performs the processing in step S118 by changing the first identification information stored in association with the first area in step S104 to the second identification information indicating a second area. Thus, the second area is in a state stored in the second storage 18 in association with the date and time when the second area was selected as the first area and the second identification information indicating the second area.

Note that the second controller 36 may perform the processing of step S118 after the processing of step S114 and before the processing of step S122.

Subsequently, the acquiring unit 26 acquires one of the third images displayed on the display 24 in step S116 as a first image (step S120). Subsequently, the receiver 28 determines whether or not selection of a first area in the first image acquired in step S120 is received (step S122).

For example, the user operates the input unit 22 while checking one or more third images displayed on the display 24 to input a first area contained in one third image. The UI unit 14 outputs the third image and the first area input by the input unit 22 to the controller 12. In the processing of step S120, the acquiring unit 26 acquires the third image received from the UI unit 14 as a first image. In addition, the receiver 28 performs the determination in step S122 by determining whether or not the first area is received from the UI unit 14.

Note that the selection of one third image from among one or more third images displayed on the display 24 and the selection of the first area made by the user are not limited to be performed at the same time as described above but may be performed in different steps.

If the receiver 28 has received selection of the first area (step S122: Yes), the process proceeds to step S104 described above. If the receiver 28 has not received selection of the first area (step S122: No), the process proceeds to step S124.

The controller 12 determines whether or not a termination instruction indicating termination of the search process is received from the UI unit 14 (step S124). For example, when the first controller 34 performs control to display the third images on the display 24 in step S116, the first controller 34 also performs control to display an instruction button image for instructing to terminate the search process on the display 24. When the area of the instruction button image is specified through an operational instruction given to the input unit 22 by the user, the UI unit 14 then outputs a signal indicating termination of the search process to the controller 12. The UI unit 14 performs the determination in step S124 by determining whether or not the signal is received.

If the controller 12 has not received the termination instruction (step S124: No), the process proceeds to step S100. If the controller 12 has received the termination instruction (step S124: Yes), the process proceeds to step S126.

In step S126, the second controller 36 stores the first area and the date and time when the first area was selected, and the second area and the date and time when the second area was selected as a first area that are stored into the second storage 18 through the series of processing from step S100 to step S124: Yes as a unit into the third storage 20. At this point, the second controller 36 changes the first identification information associated with the first area to the second identification information. Thus, the first area stored in the second storage 18 is stored as a second area in the third storage 20.

Note that the second controller 36 may store the position information of the searching device 10 when the second area stored in the second storage 18 is selected as the first area and detail information such as the name of the user operating the searching device 10 when the second area is selected as the first area in association with the second area in addition to the date and time when the second area was selected into the third storage 20.

In this manner, the third storage 20 stores the second area, the date and time when the second area was selected as the first area, the position information of the searching device 10 when the second area is selected as the first area, and the detail information such as the name of the user operating the searching device 10 when the second area is selected as the first area in association with one another. The third storage 20 can thus stores a search history in the searching device 10.

Subsequently, the second controller 36 clears the second storage 18 (step S128), and terminates the present routine.

As a result of performing the processing in steps S100 to S128 by the controller 12, sequential and interactive search in which transition of the user's interest is reflected can be performed.

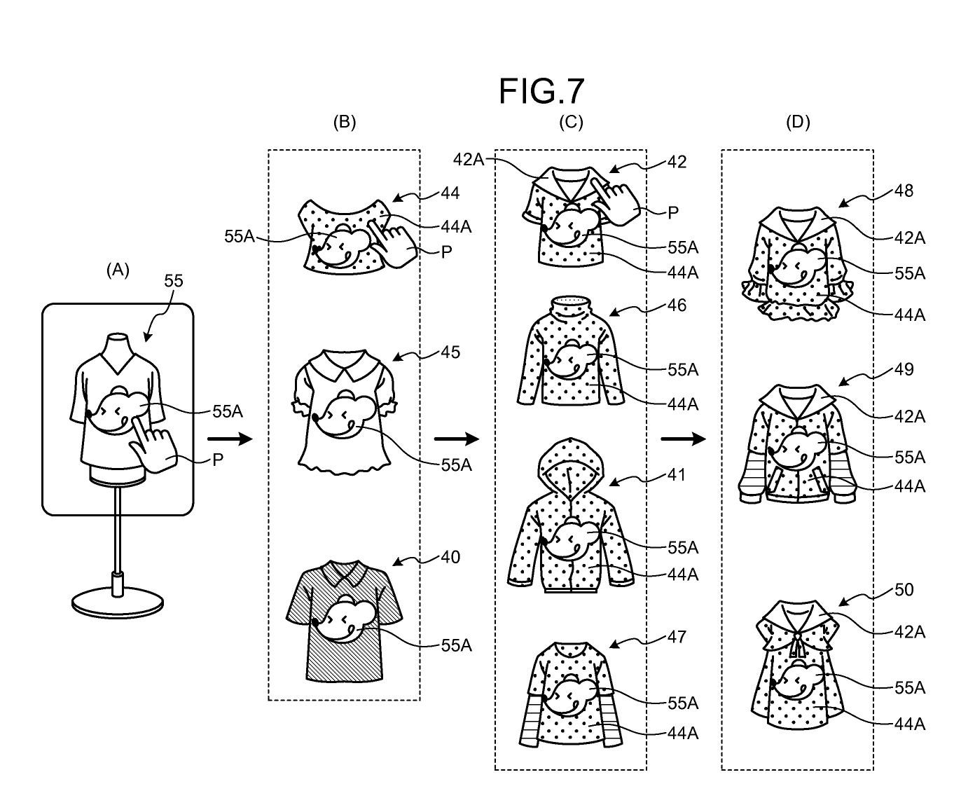

FIG. 7 illustrates transition of images displayed on the display 24 during the search process. In FIG. 7, a case in which the determining unit 32 determines a predetermined number of second images in descending order of operation results to be third images is presented.

For example, assume that the acquiring unit 26 has acquired a firs image 55 from the image capturing unit 13. The first controller 34 performs control to display the first image 55 on the display 24 ((A) in FIG. 7).

A bear mark area 55A in the first image 55 is then selected through an operational instruction given to the UI unit 14 by the user (see P in (A) in FIG. 7). As a result, the receiver 28 receives the bear mark area 55A in the first image 55 as a first area. The second controller 36 performs control to store the area 55A in association with first identification information indicating the first area into the second storage 18.

Then, as a result of performing the processing in steps S100 to S116 illustrated in FIG. 6, the determining unit 32 determines the third images 44, 45, and 40, for example. The first controller 34 performs control to display the third images 44, 45, and 40 on the display 24 (see (B) in FIG. 7). The third images 44, 45, and 40 each contain the area 55A received as the first area or an area similar to the area 55A. The second controller 36 then performs control to store the area 55A as the second area into the second storage 18 by changing the first identification information associated with the area 55A to the second identification information indicating the second area.

Furthermore, the dotted pattern area 44A is selected for the third image 44 from among the third images 44, 45, and 40 through an operational instruction given to the UI unit 14 by the user (see P in (B) in FIG. 7). As a result, the acquiring unit 26 acquires the third image 44 as a first image 44, and the receiver 28 receives the dotted pattern area 44A in the first image 44 as a first area. The second controller 36 performs control to store the area 44A in association with first identification information indicating the first area into the second storage 18.

As a result of performing the processing in steps S100 to S116 illustrated in FIG. 6, the calculator 30 calculates the first similarity and the second similarity for each of the second images by using the area 44A that is the first area and the area 55A that is the second area stored in the second storage 18. The determining unit 32 then determines the third images 42, 46, 41, and 47, for example, on the basis of the result of logical operation of the first similarity and the second similarity. The first controller 34 performs control to display the third images 42, 46, 41, and 47 on the display 24 (see (C) in FIG. 7).

The third images 42, 46, 41, and 47 each contain both of the area 44A received as the first area or an area similar to the area 44A and the area 55A as the second area or an area similar to the area 55A. The second controller 36 then performs control to store the area 44A as the second area into the second storage 18 by changing the first identification information associated with the area 44A to the second identification information indicating the second area.

Furthermore, the collar area 42A is selected for the third image 42 from among the third images 42, 46, 41 and 47 through an operational instruction given to the UI unit 14 by the user (see P in (C) in FIG. 7). As a result, the acquiring unit 26 acquires the third image 42 as a first image 42, and the receiver 28 receives the collar area 42A in the first image 42 as a first area. The second controller 36 performs control to store the area 42A in association with first identification information indicating the first area into the second storage 18.

As a result of performing the processing in steps S100 to S116 illustrated in FIG. 6, the calculator 30 calculates the first similarity and the second similarity for each of the second images by using the area 44A that is the first area and the area 55A and the area 44A that are the second areas stored in the second storage 18. The determining unit 32 then determines the third images 48, 49, and 50, for example, on the basis of the result of logical operation of the first similarity and the second similarity. The first controller 34 performs control to display the third images 48, 49, and 50 on the display 24 (see (D) in FIG. 7).

The third images 48, 49, and 50 each contain all of the area 42A received as the first area or an area similar to the area 42A, the area 55A as a second area or an area similar to the area 55A, and the area 44A as a second area or an area similar to the area 44A. The second controller 36 then performs control to store the area 42A as the second area into the second storage 18 by changing the first identification information associated with the area 42A to the second identification information indicating the second area.

In this manner, the user selects a first area each time third images are displayed on the display 24. The searching device 10 determines second images similar or dissimilar to both of the selected first area and the second areas to be third images to be presented to the user, and displays the third images on the display 24. Thus, the user can eventually display an intended second image from among the second images on the display 24 by sequentially specifying the first area.

As described above, with the searching device 10 according to the present embodiment, the acquiring unit 26 acquires a first image. The receiver 28 receives selection of a first area contained in the first image. The calculator 30 calculates first similarity with the first area and second similarity with a second area for each of second images to be searched. The determining unit 32 determines third images to be presented to the user from among the second images on the basis of the result of the logical operation of the first similarity and the second similarity.

In this manner, the searching device 10 determines the third images not on the basis of only the first similarity but on the basis of a result of logical operation using both of the first similarity and the second similarity.

The searching device 10 of the present embodiment can therefore perform sequential and interactive search in which transition of the user's interest is reflected.

In the embodiment described above, the first controller 34 performs control to display the third images on the display 24. The first controller 34, however, may perform control to display at least one of the first image, the first area, the second area, and the type of logical operation used for the logical operation together with the third images on the display 24.

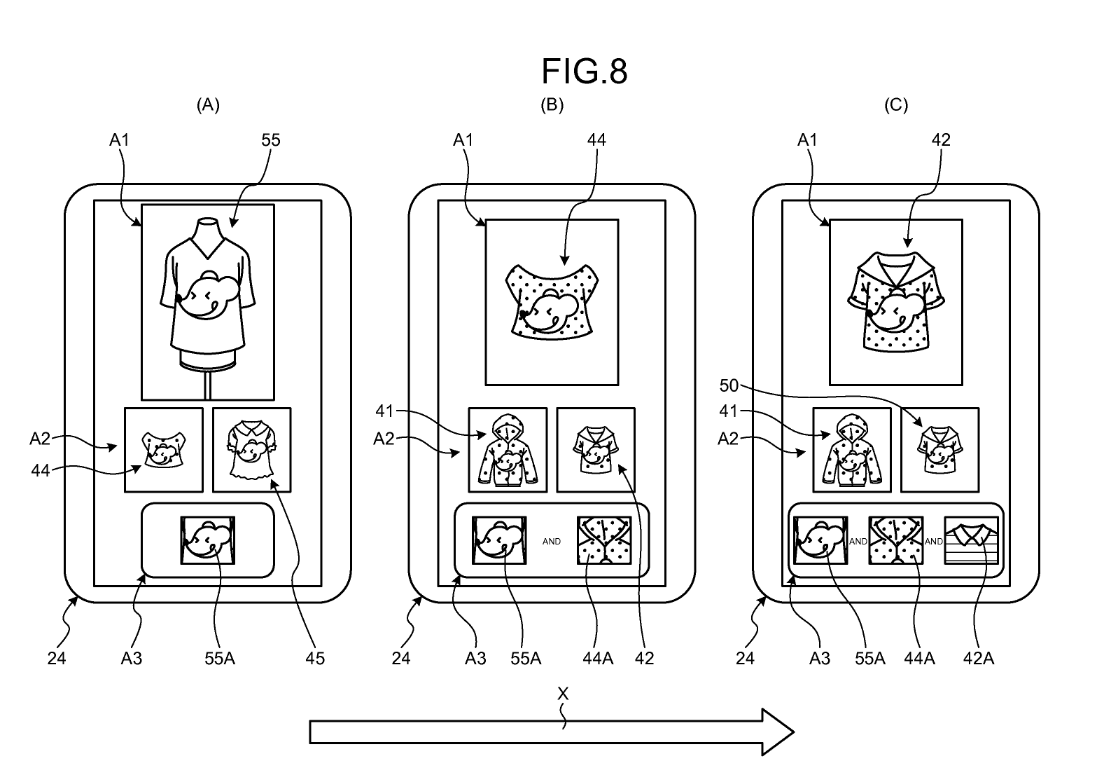

FIG. 8 illustrates display control performed by the first controller 34. For example, when third images 44 and 45 are determined, the first controller 34 performs control to display a first image 55 in an area A1 of the display 24, display the third images 44 and 45 in an area A2 of the display 24, and display an area 55A as the first area in an area A3 of the display 24 (see (A) in FIG. 8).

Subsequently, the dotted pattern area 44A is selected for the third image 44 from among the third images 44 and 45 through an operational instruction given to the UI unit 14 by the user (see (B) in FIG. 8). Furthermore, assume that the determining unit 32 determines third images 41 and 42. The first controller 34 then performs control to display the third image 44 as the first image 44 in the area A1 of the display 24, display the third images 41 and 42 in the area A2 of the display 24, and display the area 55A that is the first area, the area 44A that is the second area, and the type of logical operation “AND” used in the logical operation in the area A3 of the display 24 (see (B) in FIG. 8).

Subsequently, a collar area 42A is selected for the third image 42 from among the third images 41 and 42 through an operational instruction given to the UI unit 14 by the user (see (C) in FIG. 8). Furthermore, assume that the determining unit 32 determines third images 41 and 50. The first controller 34 then performs control to display the third image 42 as the first image 42 in the area A1 of the display 24, display the third images 41 and 50 in the area A2 of the display 24, and display the area 42A that is the first area, the area 44A and the area 55A that are the second areas, and the type of logical operation “AND” used in the logical operation in the area A3 of the display 24 (see (C) in FIG. 8).

In this manner, the first controller 34 may perform control to display at least one of the first image, the first area, the second area, and the type of logical operation used for the logical operation together with the third images on the display 24. As a result, it is possible to easily provide the user with the method for determining third images and the like.

In the present embodiment, a case in which the acquiring unit 26 acquires a first image from the image capturing unit 13 or the first storage 16 is described. However, the manner in which the acquiring unit 26 acquires a first image is not limited to acquisition from the image capturing unit 13 or the first storage 16.

For example, the acquiring unit 26 may acquire a first image from an external device via an interface unit (I/F unit) or a communication line such as the Internet, which is not illustrated. Examples of the external device include a known PC, web server, and the like.

Alternatively, the acquiring unit 26 may acquire a first image by the following method. Specifically, first, the acquiring unit 26 further has functions of a television tuner that receives airwaves from a broadcast station, which is not illustrated, as content data, a network interface that receives content data from the Internet, or the like.

The controller 12 then displays a program contained in the content data on the display 24. Instruction to capture an image from the input unit 22 is then given through the operational instruction given by the user. Specifically, the user can input an image capturing instruction from the program displayed on the display 24 by operating the input unit 22 while checking the program displayed on the display 24.

Upon receiving the image capturing instruction from the input unit 22, the acquiring unit 26 may then acquire a frame image (which may also be referred to as a frame) displayed on the display 24 when the image capturing instruction is received as a first image. Alternatively, the acquiring unit 26 may capture a frame image before the frame image (by several seconds, for example) displayed on the display 24 when the image capturing instruction is received as the first image.

In the embodiment described above, a case in which the storages 16, 18, and 20 are provided in the searching device 10. At least one of the storages 16, 18, and 20, however, may be a storage device connected to the searching device 10 via a communication line.

Programs for performing the search process to be executed by the searching device 10 according to the embodiment described above are embedded on a ROM or the like in advance and provided therefrom as a computer program product.

Alternatively, the programs for performing the search process to be executed by the searching device 10 according to the embodiment described above may be stored in a computer readable storage medium such as a CD-ROM, a flexible disk (FD), a CD-R, and a digital versatile disk (DVD) in a form of a file that can be installed or executed on the searching device 10, and provided therefrom as a computer program product.

Alternatively, the programs for performing the search process to be executed by the searching device 10 according to the embodiment described above may be stored on a computer system connected to a network such as the Internet, and provided by being downloaded via the network. Alternatively, the programs for performing the search process to be executed by the searching device 10 according to the embodiment described above may be provided or distributed through a network such as the Internet.

The programs for performing the search process to be executed by the searching device 10 according to the embodiment described above have a modular structure including the respective units (the acquiring unit 26, the receiver 28, the calculator 30, the determining unit 32, the first controller 34, and the second controller 36) described above. In an actual hardware configuration, a CPU (processor) reads the programs for performing the search process from a storage medium such as a ROM and executes the programs, whereby the respective units are loaded on a main storage device and generated thereon.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A searching device comprising:
an acquiring unit configured to acquire a first image;
a receiver configured to receive selection of a first area contained in the first image;
a calculator configured to calculate, for each of a plurality of second images to be searched, a first similarity with the first area and a second similarity with a second area that has been received by the receiver before the first area; and
a determining unit configured to determine a third image or third images to be presented from among the second images on the basis of a result of a logical operation of the first similarity and the second similarity for each of the second images.

2. The device according to claim 1, wherein the acquiring unit is configured to acquire one of the third images as the first image.

3. The device according to claim 1, wherein the determining unit is configured to determine, as the third images, a predetermined number of second images in descending order or in ascending order of the results of the logical operation.

4. The device according to claim 1, wherein the determining unit is configured to determine the third image on the basis of the result of the logical operation using at least one of a logical product, a logical sum, a negation, and an exclusive OR.

5. The device according to claim 1, wherein the determining unit is configured to determine the third image on the basis of the result of the logical operation obtained by sequentially using a type of logical operation associated with a predetermined order of operation on the first similarity and each of the second similarities.

6. The device according to claim 1, wherein the determining unit is configured to
set a first truth value that defines the first similarity exceeding a first threshold to be true and defines the first similarity equal to or smaller than the first threshold to be false,
set a second truth value that defines the second similarity exceeding a second threshold to be true and defines the second similarity equal to or smaller than the second threshold to be false, and
determine the third image on the basis of a result of an operation of the first truth value for the first similarity and the second truth value for the second similarity for each of the second images.

7. The device according to claim 1, wherein the calculator is configured to calculate the first similarity by using a first feature of the first area, a geometric relation of the first area in the first image, a third feature of a third area corresponding to the first area in the second image, and a geometric relation of the third area in the second image.

8. The device according to claim 1, wherein the calculator is configured to calculate the second similarity by using a second feature of the second area, a geometric relation of the second area in the first image, a fourth feature of a fourth area corresponding to the second area in the second image, and a geometric relation of the fourth area in the second image.

9. The device according to claim 1, further comprising a first controller configured to perform control to display the third image on a display.

10. The device according to claim 9, wherein the first controller is configured to perform control to display, on the display, the third image and at least one of the first image, the first area, the second area, and a type of logical operation used for obtaining the result of the operation.

11. The device according to claim 1, further comprising a second controller configured to perform control to store the first area into a second storage when selection of the first area is received, and perform control to store the first area as the second area into the second storage when the third image is determined.

12. The device according to claim 11, wherein the second controller is configured to perform control to store the second area stored in the second storage in association with a date and time on which the second area was selected as the first area into a third storage.

13. A searching device comprising:
a receiver configured to receive selection of a first area contained in a first image; and
a determining unit configured to determine a second image similar or dissimilar to both of the first area and a second area that has been received by the receiver before the first area, from among a plurality of second images to be searched, as a third image to be presented, on the basis of a result of a logical operation of a first similarity with the first area and a second similarity with the second area for each of the second images.

14. A searching method comprising:
acquiring a first image;
receiving selection of a first area contained in the first image;
calculating, for each of a plurality of second images to be searched, a first similarity with the first area and a second similarity with a second area that has been received by the receiver before the first area; and
determining a third image or third images to be presented from among the second images on the basis of a result of a logical operation of the first similarity and the second similarity for each of the second images.

15. The method according to claim 14, wherein the acquiring includes acquiring one of the third images as the first image.

16. The method according to claim 14, wherein the determining includes determining, as the third images, a predetermined number of second images in descending order or in ascending order of the results of the logical operation.

17. The method according to claim 14, wherein the determining includes determining the third image on the basis of the result of the logical operation using at least one of a logical product, a logical sum, a negation, and an exclusive OR.

18. The method according to claim 14, wherein the determining includes determining the third image on the basis of the result of the logical operation obtained by sequentially using a type of logical operation associated with a predetermined order of operation on the first similarity and each of the second similarities.

19. The method according to claim 14, wherein the determining includes
setting a first truth value that defines the first similarity exceeding a first threshold to be true and defines the first similarity equal to or smaller than the first threshold to be false,
setting a second truth value that defines the second similarity exceeding a second threshold to be true and defines the second similarity equal to or smaller than the second threshold to be false, and
determining the third image on the basis of a result of an operation of the first truth value for the first similarity and the second truth value for the second similarity for each of the second images.

20. The method according to claim 14, wherein the calculating includes calculating the first similarity by using a first feature of the first area, a geometric relation of the first area in the first image, a third feature of a third area corresponding to the first area in the second image, and a geometric relation of the third area in the second image.

21. The method according to claim 14, wherein the calculating includes calculating the second similarity by using a second feature of the second area, a geometric relation of the second area in the first image, a fourth feature of a fourth area corresponding to the second area in the second image, and a geometric relation of the fourth area in the second image.

22. The method according to claim 14, further comprising performing a first control to display the third image on a display.

23. The method according to claim 22, wherein the first control includes displaying, on the display, the third image and at least one of the first image, the first area, the second area, and a type of logical operation used for obtaining the result of the operation.

24. The method according to claim 14, further comprising performing a second control to store the first area into a second storage when selection of the first area is received, and performing control to store the first area as the second area into the second storage when the third image is determined.

25. The method according to claim 24, wherein the second control includes storing the second area stored in the second storage in association with a date and time on which the second area was selected as the first area into a third storage.

26. A computer program product comprising a computer-readable medium containing a program executed by a computer, the program causing the computer to execute:
acquiring a first image;
receiving selection of a first area contained in the first image;
calculating, for each of a plurality of second images to be searched, a first similarity with the first area and a second similarity with a second area that has been received by the receiver before the first area; and
determining a third image or third images to be presented from among the second images on the basis of a result of a logical operation of the first similarity and the second similarity for each of the second images.

27. The product according to claim 26, wherein the acquiring includes acquiring one of the third images as the first image.

28. The product according to claim 26, wherein the determining includes determining, as the third images, a predetermined number of second images in descending order or in ascending order of the results of the logical operation.

29. The product according to claim 26, wherein the determining includes determining the third image on the basis of the result of the logical operation using at least one of a logical product, a logical sum, a negation, and an exclusive OR.

30. The product according to claim 26, wherein the determining includes determining the third image on the basis of the result of the logical operation obtained by sequentially using a type of logical operation associated with a predetermined order of operation on the first similarity and each of the second similarities.

31. The product according to claim 26, wherein the determining includes
setting a first truth value that defines the first similarity exceeding a first threshold to be true and defines the first similarity equal to or smaller than the first threshold to be false,
setting a second truth value that defines the second similarity exceeding a second threshold to be true and defines the second similarity equal to or smaller than the second threshold to be false, and
determining the third image on the basis of a result of an operation of the first truth value for the first similarity and the second truth value for the second similarity for each of the second images.

32. The product according to claim 26, wherein the calculating includes calculating the first similarity by using a first feature of the first area, a geometric relation of the first area in the first image, a third feature of a third area corresponding to the first area in the second image, and a geometric relation of the third area in the second image.

33. The product according to claim 26, wherein the calculating includes calculating the second similarity by using a second feature of the second area, a geometric relation of the second area in the first image, a fourth feature of a fourth area corresponding to the second area in the second image, and a geometric relation of the fourth area in the second image.

34. The product according to claim 26, wherein the program causes the computer to further execute performing a first control to display the third image on a display.

35. The product according to claim 34, wherein the first control includes displaying, on the display, the third image and at least one of the first image, the first area, the second area, and a type of logical operation used for obtaining the result of the operation.

36. The product according to claim 26, wherein the program causes the computer to further execute performing a second control to store the first area into a second storage when selection of the first area is received, and performing control to store the first area as the second area into the second storage when the third image is determined.

37. The product according to claim 36, wherein the second control includes storing the second area stored in the second storage in association with a date and time on which the second area was selected as the first area into a third storage.
